(19) United States
(12) Patent Application Publication
(10) Pub. No.: US 2010/0308499 A1
(43) Pub. Date: Dec. 9, 2010

(54) METHOD FOR FORMING A COMPOSITE LAMINATE

(75) Inventors: Mei-Yu Chen, Fongshan City (TW); Chang-Hung Tsai, Kaohsiung City (TW)

Correspondence Address: BANNER & WITCOFF, LTD., 1100 13th STREET, N.W., SUITE 1200, WASHINGTON, DC, 20005-4051, US

(73) Assignee: ADVANCED INTERNATIONAL MULTITECH CO., LTD., Kaohsiung City (TW)

(21) Appl. No.: 12/577,995

(22) Filed: Oct. 13, 2009

(30) Foreign Application Priority Data
Jun. 9, 2009 (TW) 098119191

(51) Int. Cl. B29C 70/06

(52) U.S. Cl. 264/241

(57) ABSTRACT

A method for forming a composite laminate includes: providing an upper die and a lower die; disposing the composite laminate over a die cavity of the lower die, and lowering the upper die onto the composite laminate and thereafter into the die cavity so as to hot press the composite laminate; folding inwardly a marginal end of the composite laminate that extends outwardly of the die cavity; removing the lower die from the upper die; and removing the upper die from the hot-pressed composite laminate.

### CROSS-REFERENCE TO RELATED APPLICATION

This application claims priority of Taiwanese application no. 098119191, filed on Jun. 9, 2009.

### BACKGROUND OF THE INVENTION

1. Field of the Invention

This invention relates to a method for forming a composite laminate, more particularly to a method for forming a composite laminate into a housing or the like having an inward flange.

2. Description of the Related Art

A composite laminate having a plurality of fabric layers impregnated with a resin usually has a lightweight property and is excellent in both heat resistance and corrosion resistance. Thus, it is widely used in making housings or cases for 3C information products, such as notebook computers, mobile phones, PDA, etc.

FIGS. 1 to 3 show a conventional method for forming a composite laminate 1 having a plurality of fabric layers impregnated with a resin. The method includes: step 11 of providing a mold 100 including upper and lower dies 101, 102; step 12 of disposing the composite laminate 1 between the upper and lower dies 101, 102 so as to hot press the composite laminate 1; and step 13 of removing the hot-pressed composite laminate 1 from the mold 100. By the above steps, a composite product 2 having an outwardly expanding stepped wall is formed.

However, with the use of the conventional method, it is impossible to make a composite product 3 having an integrally formed inward flange 33 as shown in FIG. 4. Therefore, in practice, when making the composite product 3, the inward flange 33 and the remaining part of the composite product 3 are molded separately, and are subsequently assembled together such as by gluing. Accordingly, such composite product 3 is prone to break at the inward flange 33.

Moreover, for better appearance, it is usually necessary to cover an outer surface of the composite product 3 with an outer layer through a spraying or gluing process so as to shield a joint between the inward flange 33 and the rest of the composite product 3, thereby increasing the manufacturing cost.

### SUMMARY OF THE INVENTION

An object of the present invention is to provide a novel method for forming a composite laminate that can overcome the aforesaid drawbacks of the prior art.

Accordingly, there is provided a method for forming a composite laminate having a plurality of fabric layers impregnated with a resin according to the present invention. The method comprises:
(a) providing an upper die and a lower die, the lower die having a die cavity, the upper die having a central main body, and a peripheral flange body disposed around the central main body, the peripheral flange body being formed by assembling a plurality of die parts disposed around the central main body and having a peripheral bottom flange that projects outwardly;
(b) disposing the composite laminate over the die cavity, and lowering the upper die onto the composite laminate and thereafter into the die cavity so as to hot press the composite laminate, wherein a major laminate part of the composite laminate is pressed by the central main body and the peripheral flange body within the die cavity to form a bottom wall, a lateral laminate part of the composite laminate around the major laminate part flexes upwardly from the major laminate part and around the peripheral flange body to form a surrounding wall extending upwardly from the bottom wall, and a marginal end extends upwardly from the lateral laminate part and outwardly of the die cavity; and
(c) folding inwardly the marginal end so that the marginal end is formed into an inward flange that projects transversely and inwardly from the surrounding wall.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a flowchart showing a conventional method for forming a composite laminate;

FIG. 2 is a schematic view illustrating a mold for hot pressing a composite laminate by the conventional method;

FIG. 3 is a perspective partly cutaway view of a composite product having an outwardly expanding stepped wall;

FIG. 4 is a perspective view of a composite product having an inward flange;

FIG. 5 is a cross-sectional view of the composite product of FIG. 4;

FIG. 6 is a flowchart showing a method for forming a composite laminate according to the first embodiment of the present invention;

FIG. 7 is a fragmentary cross-sectional view of an upper die used in the method according to the first embodiment of the present invention;

FIG. 8 is a plan view of a peripheral flange body of the upper die of FIG. 7;

FIG. 9 is a cross-sectional view taken along line IX-IX of FIG. 8;

FIG. 10 is a fragmentary cross-sectional view of a mold used in the method according to the first embodiment of the present invention to form a composite laminate, wherein a marginal end of the composite laminate extends outwardly of a die cavity;

FIG. 11 is the same view as FIG. 10 but illustrating that the marginal end of the composite laminate is folded inwardly; and

FIG. 12 is plan view of a peripheral flange body of another upper die.

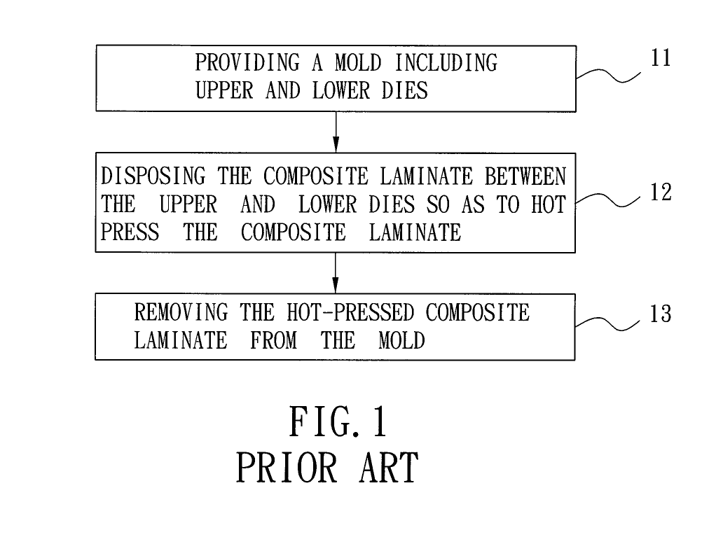

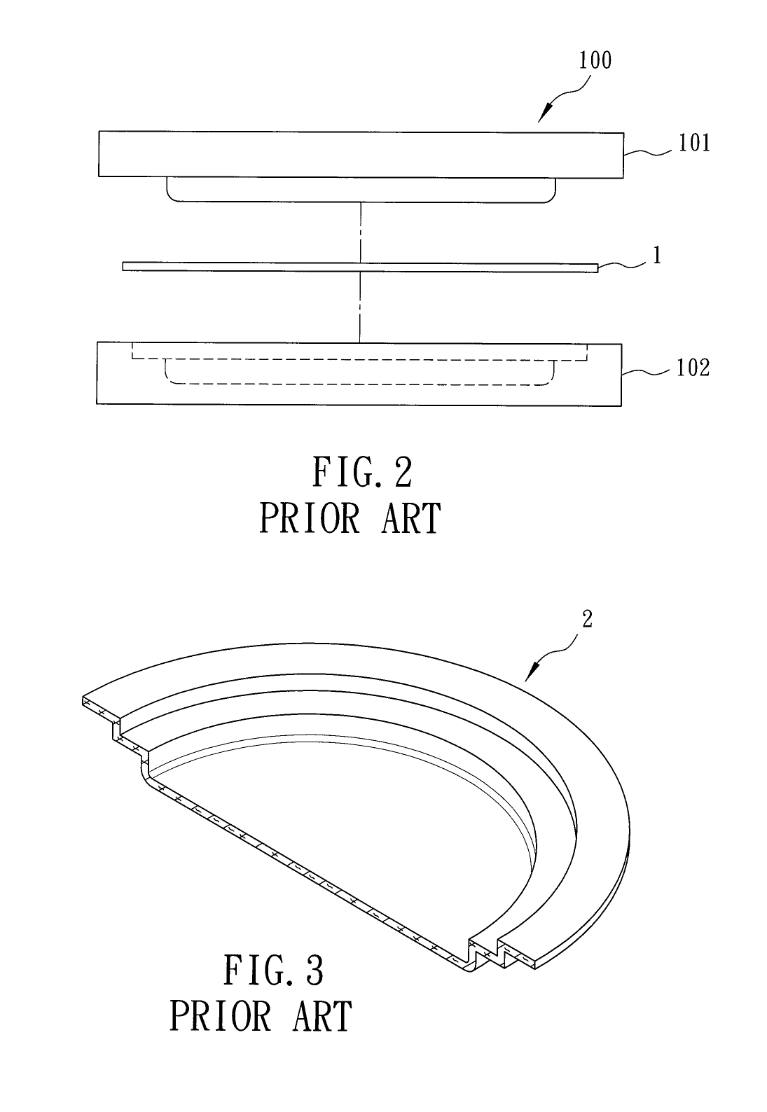

### DETAILED DESCRIPTION OF THE PREFERRED EMBODIMENTS

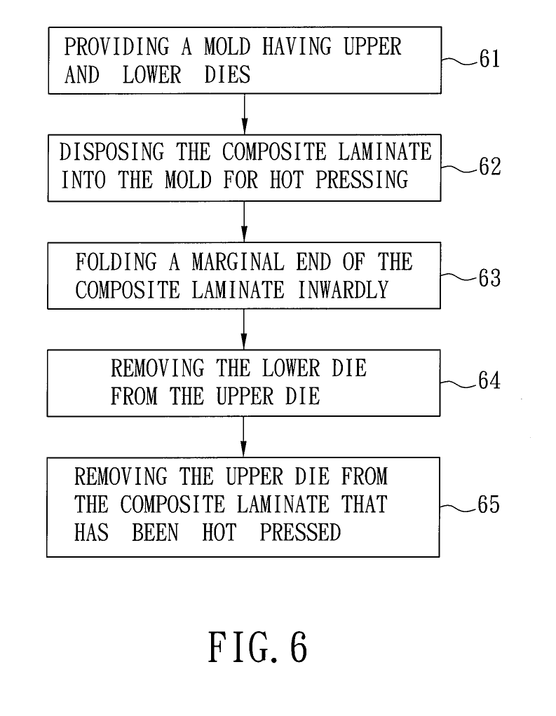

FIG. 6 illustrates a method for forming a composite laminate according to the first embodiment of the present invention.

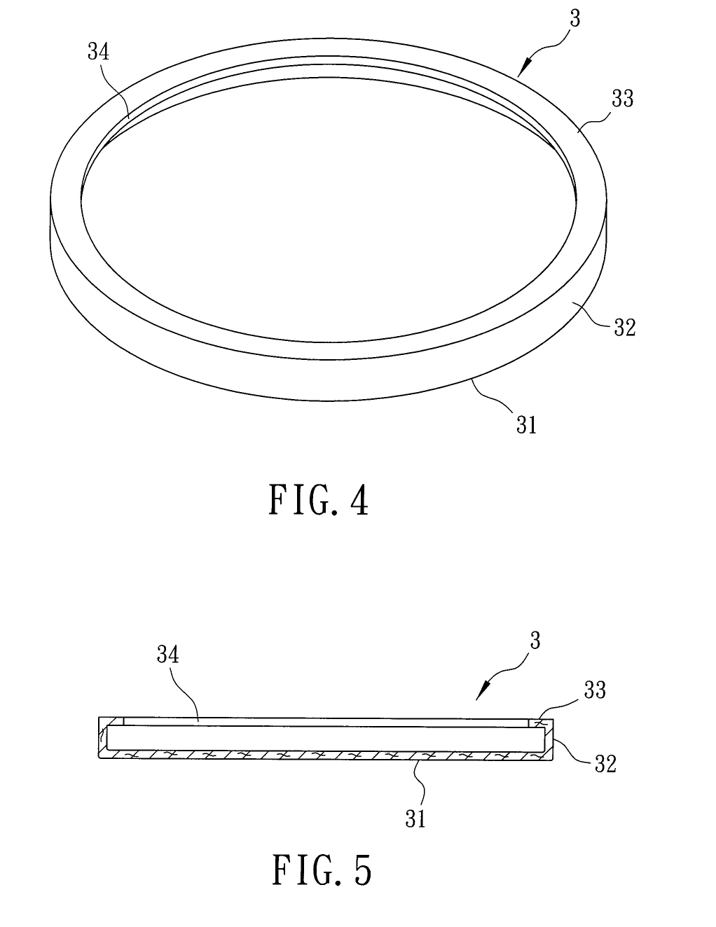

Referring back to FIGS. 4 and 5, the composite product 3 has a bottom wall 31, a surrounding wall 32 extending upwardly from the bottom wall 31, and an inward flange 33 projecting inwardly and transversely from a top end of the surrounding wall 32 and defining an opening 34 above the bottom wall 31.

The composite product 3 can be used as a housing for a 3C information product. As the composite product 3 is a one-piece product that has no seam, it is not liable to break into parts and has an improved appearance.

The composite product 3 can be made from a composite laminate by employing the method according to the first embodiment of the present invention. The composite laminate may be prepared by laminating a plurality of fabric layers impregnated with a resin, followed by pressurizing the fabric layers or vacuum pumping to remove air bubbles from the fabric layers. In this embodiment, the fabric layers are carbon fiber layers.

Referring to FIGS. 6 to 11, the method comprises step 61 of providing a mold having upper and lower dies 4, 5, step 62 of disposing the composite laminate 30 into the mold for hot pressing, step 63 of folding a marginal end of the composite laminate 30 inwardly, step 64 of removing the lower die 5 from the upper die 4, and step 65 of removing the upper die 4 from the composite laminate 30 that has been hot pressed.

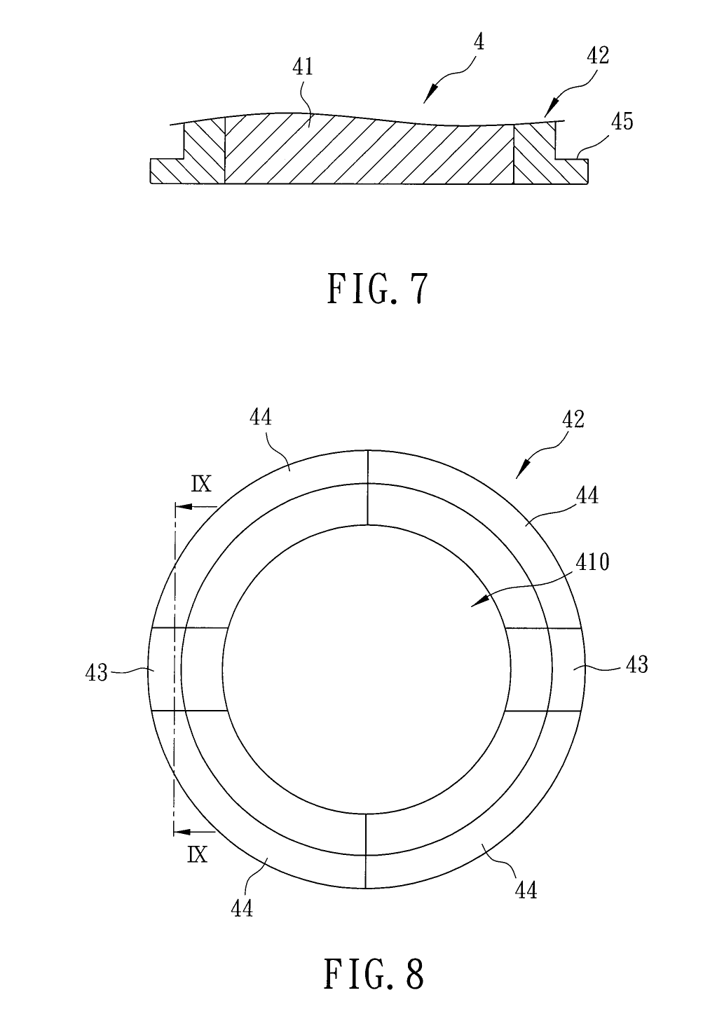

In step 61, the lower die 5 is provided with a die cavity 50. The upper die 4 is provided with a central main body 41, and a peripheral flange body 42 disposed around the central main body 41, as shown in FIGS. 7 to 11. The central main body 41 is substantially cylindrical in this embodiment. The peripheral flange body 42 is formed by assembling a plurality of die parts 43, 44 disposed around the central main body 41 and has a peripheral bottom flange 45 that projects outwardly.

In this embodiment, the die parts 43, 44 of the peripheral flange body 42 include two opposite first die parts 43 and two pairs of arcuate second die parts 44. The first die parts 43 can be moved oppositely and inwardly into a space 410 that is left after the central main body 41 is removed from the peripheral flange body 42.

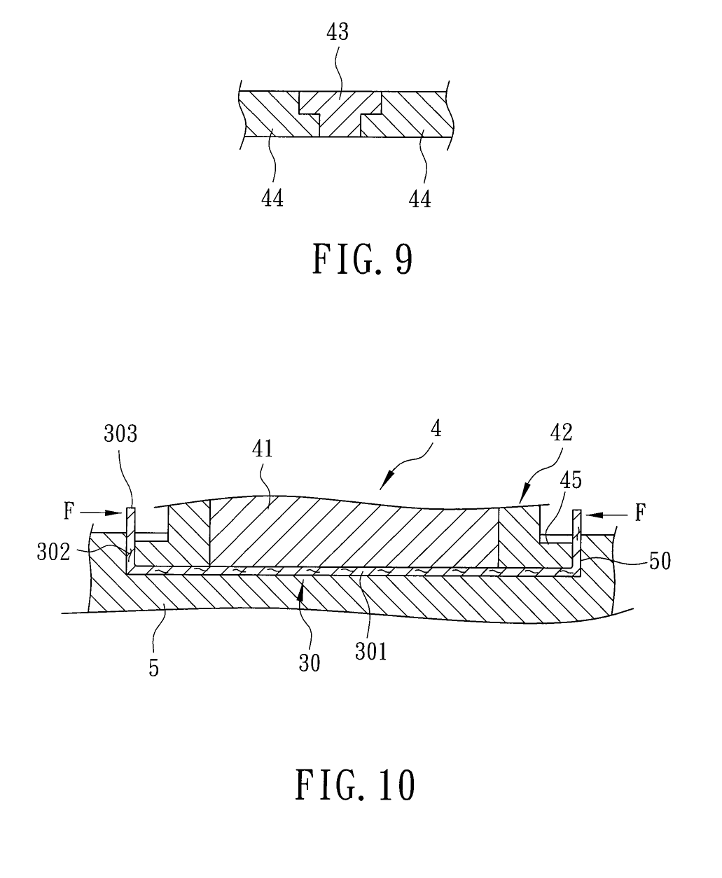

As best shown in FIGS. 8 and 9, when the die parts 43, 44 of the peripheral flange body 42 are assembled, each pair of the arcuate second die parts 44 are assembled together between the first die parts 43, and each first die part 43 is detachably engaged with two adjacent second die parts 44.

In step 62, the composite laminate 30 is disposed over the die cavity 50, and the upper die 4 is lowered onto the composite laminate 30 and thereafter into the die cavity 50 so as to hot press the composite laminate 30. As shown in FIG. 10, in this step, a major laminate part 301 of the composite laminate 30 is pressed by the central main body 41 and the peripheral flange body 42 within the die cavity 50 to form the bottom wall 31 of the composite product 3 shown in FIG. 5. A lateral laminate part 302 of the composite laminate 30 around the major laminate part 301 flexes upwardly from the major laminate part 301 and around the peripheral flange body 42 to form the surrounding wall 32 (FIG. 5) of the composite product 3. A marginal end 303 extends upwardly from the lateral laminate part 302 and outwardly of the die cavity 50.

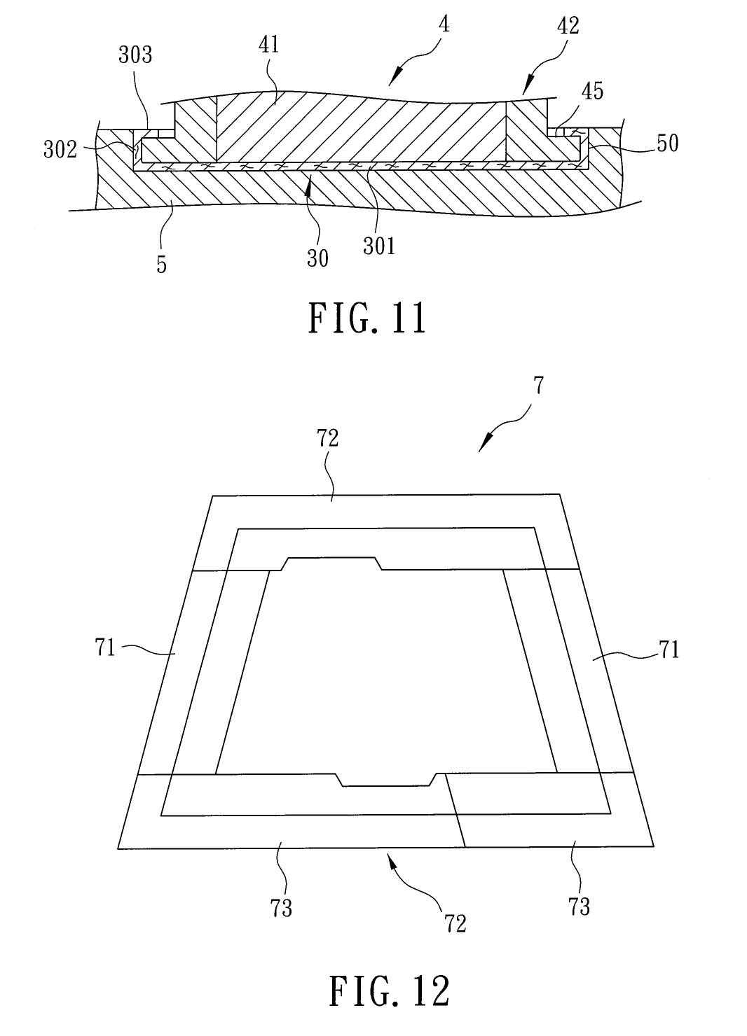

In step 63, the marginal end 303 is folded inwardly in a direction (F) shown in FIG. 10. As such, the marginal end 303 projects inwardly from the lateral laminate part 302 and is folded over the peripheral bottom flange 45 of the peripheral flange body 42 (see FIG. 11), thereby forming the inward flange 33 of the composite product 3 (FIG. 5). The marginal end 303 can be folded manually or using a suitable mechanical means while the composite laminate 30 is hot.

In step 64, the lower die 5 is removed from the upper die 4.

In step 65, the upper die 4 is removed from the hot-pressed composite laminate 30 by first removing the central main body 41 from the peripheral flange body 42, and thereafter disassembling the die parts 43, 44 of the peripheral flange body 42. In detail, the first die parts 43 are removed by sliding the first die parts 43 relative to the second die parts 44 so as to move the first die parts 43 oppositely and inwardly into the space 410 (FIG. 8). After removal of the first die parts 43 from the hot-pressed composite laminate 30, the arcuate second die parts 44 are separated from each other so that they can be removed from the hot-pressed composite laminate 30.

By the above steps, the composite product 3 as formed is a one-piece product.

The mold used in the method of the present invention can be modified according to the shape of the composite product to be made. When the composite product is in a quadrangle-shaped (for example, a trapezium-shaped), the upper die of the mold may be provided with a four-sided central main body (not shown) and a peripheral flange body 7 as shown in FIG. 12. The peripheral flange body 7 is formed by assembling two opposite first die parts 71 and two second die parts 72. The first die parts 71 extend between the second die parts 72. The second die parts 72 are substantially parallel, and one of the second die parts 72 is divided into two separable sub-die sections 73.

An alternative method for forming the composite laminate 30 is provided according to a second preferred embodiment of the present invention. The second embodiment differs from the first embodiment only in that the method further comprises a step of attaching release films (not shown) on upper and lower surfaces of the composite laminate 30 for preventing the resin contained in the composite laminate 30 from adhering to the upper and lower dies 4, 5. The step of attaching the release film is conducted before step 61.

The release films can be made of polyethylene terephthalate, ortho-phenylphenol, or combinations thereof. By virtue of the release films, removal of the upper and lower dies 4, 5 from the hot-pressed laminate 30 is made easier. With the use of the release films, the need to remove residual resin of the composite laminate 30 from the upper and lower dies 4,5 can be eliminated.

Alternatively, the release film may be made of a material that is soluble in a solvent used for coating the surface of the composite product 3. One example of the material is triacetate cellulose (TAC). As the release film of this type can be combined with the coating on the surface of the composite product 3, it is not necessary to remove the release film from the composite product 3 as formed by the method of the present invention.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A method for forming a composite laminate having a plurality of fabric layers impregnated with a resin, the method comprising:
(a) providing an upper die and a lower die, the lower die having a die cavity, the upper die having a central main body, and a peripheral flange body disposed around the central main body, the peripheral flange body being formed by assembling a plurality of die parts disposed around the central main body and having a peripheral bottom flange that projects outwardly;
(b) disposing the composite laminate over the die cavity, and lowering the upper die onto the composite laminate and thereafter into the die cavity so as to hot press the composite laminate, wherein a major laminate part of the composite laminate is pressed by the central main body and the peripheral flange body within the die cavity to form a bottom wall, a lateral laminate part of the composite laminate around the major laminate part flexes upwardly from the major laminate part and around the peripheral flange body to form a surrounding wall extending upwardly from the bottom wall, and a marginal end extends upwardly from the lateral laminate part and outwardly of the die cavity; and
(c) folding inwardly the marginal end so that the marginal end is formed into an inward flange that projects transversely and inwardly from the surrounding wall.

2. The method of claim 1, further comprising:
(d) removing the lower die from the upper die; and
(e) removing the upper die from the composite laminate that has been hot pressed by first removing the central main body from the peripheral flange body, and thereafter disassembling and removing the die parts of the peripheral flange body from the hot-pressed composite laminate.

3. The method of claim 1, further comprising, before step (a), a step (f) of attaching release films on upper and lower surfaces of the composite laminate for preventing the resin contained in the composite laminate from adhering to the upper and lower dies.

4. The method of claim 3, wherein the release films are made of a material selected from a group consisting of triacetate cellulose, polyethylene terephthalate, ortho-phenylphenol, and combinations thereof.

5. The method of claim 2, wherein the die parts of the peripheral flange body include two opposite first die parts which can be moved oppositely and inwardly into a space that is left after the central main body is removed from the peripheral flange body.

6. The method of claim 5, wherein the central main body is substantially cylindrical, and the die parts of the peripheral flange body further include two pairs of arcuate second die parts, each pair of the arcuate second die parts being assembled together between the first die parts.

7. The method of claim 5, wherein the central main body is four-sided, and the die parts of the peripheral flange body further includes two second die parts which are substantially parallel, the first die parts extending between the second die parts, one of the second die parts being divided into two separable sub-die sections.
